(19) United States
(12) Patent Application Publication
(10) Pub. No.: US 2009/0257808 A1
(43) Pub. Date: Oct. 15, 2009

(54) CLOSED LOOP SHEET CONTROL IN PRINT MEDIA PATHS

(75) Inventor: Martin Krucinski, Webster, NY (US)

Correspondence Address: FAY SHARPE / XEROX - ROCHESTER, 1228 EUCLID AVENUE, 5TH FLOOR, THE HALLE BUILDING, CLEVELAND, OH, 44115, US

(73) Assignee: Xerox Corporation, Norwalk (US)

(21) Appl. No.: 12/103,253

(22) Filed: Apr. 15, 2008

(51) Int. Cl. B41J 11/00

(52) U.S. Cl. 400/582

(57) ABSTRACT

A method of controlling sheet flow in digital print engines in which the nip rollers are driven independently by individual variable speed motors and sheet position sensors are disposed at each path gate and bend. The sensors provide sheet position/velocity signals to a controller which varies the speed of the individual nip drive motors according to an algorithm to prevent mis-positioning of the sheets and jamming.

### BACKGROUND

The present disclosure relates to digital photocopying and printing on print media sheets and particularly such processes in which the media sheets are fed serially from at least one tray or feeder and may traverse any of several chosen paths through one or a multiplicity of marking engines. In such photocopying and printing, the media sheets typically pass through a myriad of nip rollers and gates where the transport speed may be varied and the sheets are directed around numerous bends and the sheets may also be inverted for duplex printing or printing on both sides of the media sheet.

Heretofore, in digital photocopying/printing and particularly with electrostatic photocopiers, the media sheet path is chosen by the electronic programmer once the user has inputted the print job requirements. The sheets are fed and transported through the marking engine(s) with occasional or very limited sheet position readings by sensors located along the sheet path for providing a basis for correcting the timing of the media sheet feed into the marking engine(s) and the progress of the media sheets through the marking engine(s). The progression of media sheets through the marking engine(s) has thus essentially been accomplished by open loop control.

Where media sheets progress through a complicated transport path of multiple nip rollers, bends, and gates, variations in the path length due to varying properties of the print sheet media such as varying length, variations in the velocity on the surface of the nip rollers, variations in the bends through which the sheet traverses have allowed sheet positioning errors to compound thereby resulting in collisions, mis-registrations and jamming. Problems of this sort have been particularly acute in arrangements where large documents are to be printed at high speed in parallel paths through multiple marking engines. The combination of high sheet velocity and extended complex sheet paths are intolerant of substantial variations in the timing of the sheet position along the path in order to prevent collisions, mis-registration and jamming.

Thus, it has been desired to provide a way or means of improving the media sheet control and transport through marking engines in digital printing in a manner which eliminates or minimizes mis-registration and jamming.

### BRIEF DESCRIPTION

The present disclosure describes a method of controlling print sheet media traverse through complex or multiple paths in digital marking engines. The progression of the sheets through the path established by the electronic controller, for the particular user requested print job, provides for each of the nip rollers to be driven by individual variable speed motors; and, sheet position sensors are disposed at each of the bends and gates in the path to provide information to the controller upon the arrival of a sheet at that sensor station. The controller then applies a correction algorithm to generate a control signal for the motor drive of the proximate nip rollers to correct for any errors in the sheet position with respect to the planned program through the chosen media path in order to prevent mis-registration and jamming. Thus, the individual variable speed drive to each of the nip rollers enables the controller to correct for mis-positioning of the sheets irrespective of the location of the positioning error within the marking engine thereby providing essentially closed loop control within the system and particularly the media path.

### BRIEF DESCRIPTION OF THE DRAWINGS

FIG. 1 is a pictorial schematic of a plurality of image marking engines illustrating a complex media path;

FIG. 2 is an overall block flow diagram of the control system of the present disclosure;

FIG. 3 is a pictorial representation of the portion of the sheet media path through a marking engine employing the control of the present disclosure;

FIG. 4 is a view of a segment of the media path in a marking engine employing the method of the present disclosure;

FIG. 5 is a block flow diagram of the control strategy of the present disclosure;

FIG. 6 is a graph of a estimated sheet position and actual sheet position as a function of time for the control of the present disclosure;

FIG. 7 is a graphical presentation of a sheet position error as a function of time for a portion of the media path of FIG. 1;

FIG. 8 is a graphical presentation of sheet position error as a function of progression through the media path of FIG. 3;

FIG. 9 is a graphical presentation of the sheet position error as a function of distance progressed through the media path of FIG. 3 for a print job using the control technique of the prior art; and

FIG. 10 is a graphical presentation similar to FIG. 9 of another print job employing prior art control technique.

### DETAILED DESCRIPTION

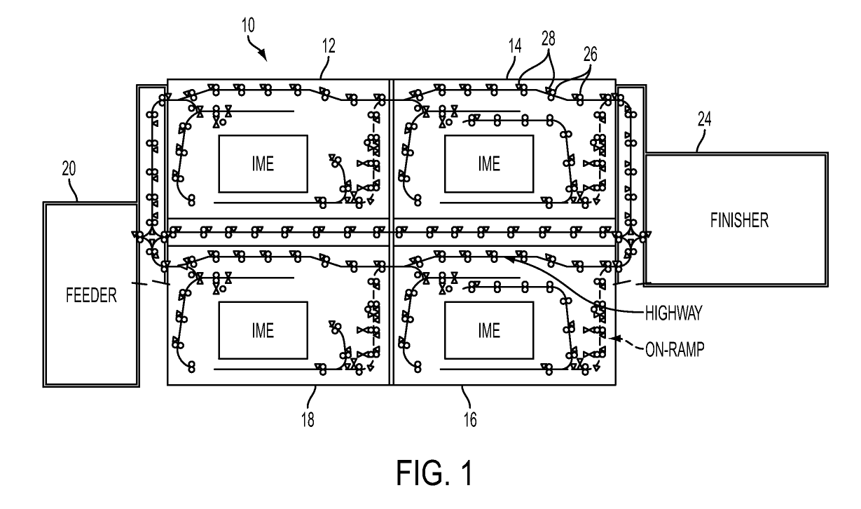

Referring to FIG. 1, an arrangement for a photocopier/printer is indicated generally at 10 includes a plurality of image marking engines 12, 14, 16, 18 arranged to receive media sheets from at least one feeder 20 and to output printed sheets to a finisher as indicated generally at 24. It will be understood that each of the marking engines includes various processing paths and inter-engine transport paths for accomplishing the desired marking on the print media sheets as for example, single or duplex printing, and thus may require sheet inverters as is known in the art of digital printing.

Each of the marking engines 12, 14, 16, 18 have intermediate paths therein determined by a plurality of pairs of nip rollers 26 and sensors 28 located therealong for defining and monitoring the movement of sheet media along a given path determined by the controller for the print job as will hereinafter be described in greater detail.

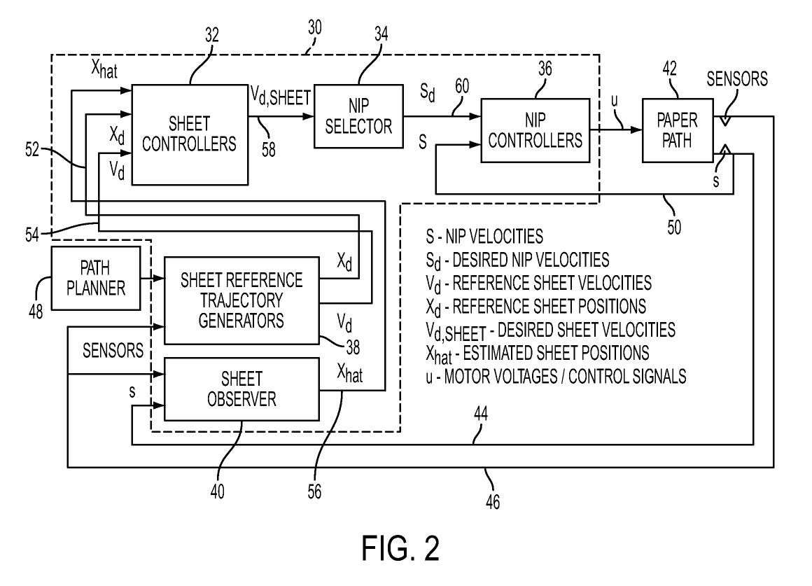

Referring to FIG. 2, a media path controller indicated generally at 30, includes sheet controllers 32 and nip selector 34, nip controller 36, sheet reference trajectory generators 38, and sheet observer 40. The nip controllers provide a voltage signal, denoted u, to the nip roller motors along the paper path as indicated by reference numeral 42. The sensors provide nip velocity output signals denoted by the reference character “s” along line 44 and sheet present sensor signals denoted by “Sensors” along line 46 to the input of the trajectory generators 38 and the sheet observer 40. The sheet reference trajectory generators 38 also receive input instructions from the path planner controller 48 based upon user inputs (not shown) for the printing job.

The sheet reference trajectory generators 38 provide an output along line 52 to the sheet controllers 32 of the reference sheet positions x_{d} and an output along line 54 of the reference sheet velocities v_{d} to the sheet controllers 32.

Referring to FIG. 2, the sheet reference trajectory generators 38 generate the desired sheet trajectories including the positions and velocities x_{d} and v_{d} for each sheet that enters the system using information from the planner 48. The reference trajectories are designed to provide desired velocity matching between the various locations in the media path such as for the on-ramp and highway locations wherein the on-ramp trajectories start at printer exit velocity and end at the highway velocity.

The sheet observer 40 provides an output along line 56 to the sheet controllers 32 of the estimated sheet positions xₕₐₜ. The sheet controllers 32 provide an input along line 58 of the desired sheet velocities v_{d,sheet} to the nip selector 34 which provides an output along line 60 of the desired nip velocities s_{d} to the nip controllers 36.

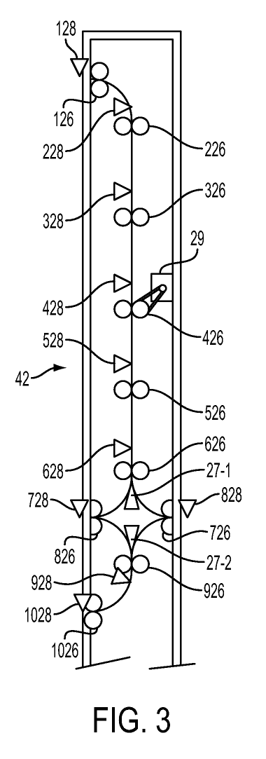

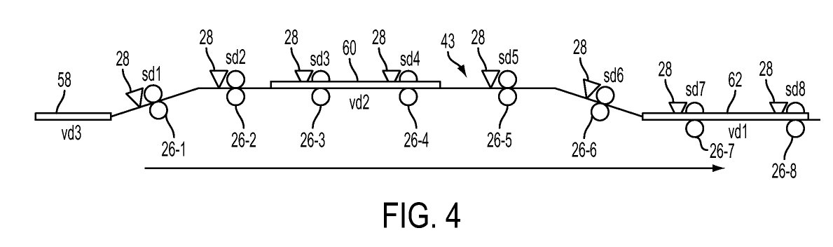

Referring to FIGS. 3 and 4, the media or paper path 42 is illustrated for a module 43 comprising a module with individual pairs of nip rollers 126, 226, 326, 426, 526, 626, 726, 826, 926, 1026 shown along the path as are gates 27-1 and 27-2. The sensors 28 are disposed with each pair of nip rollers. Referring to FIG. 3, each of the nip roller pairs 26 is driven by an individual drive motor 29 only one of which is shown in FIG. 3 for the sake of clarity of illustration; however, it will be understood that an individual motor is provided for each of the nip roller pairs 26 and is connected to the nip controllers 36. Each of the nip roller pairs and gates has a sensor denoted respectively 128, 228, 328, 428, 528, 628, 728, 828, 928, 1028 disposed closely adjacent thereto for sensing media position and velocity of the adjacent nip station.

Referring to FIG. 3, the gates denoted 27-1 and 27-2 are solenoid operated for choosing the exit path for the media which enters the module or path segment at the upper left hand set of nip rollers 26 and exits at the lower set of nip rollers as determined by the choice of energization of solenoid 27-1 or solenoid 27-2.

Referring to FIG. 4, a portion of another media path 43 is shown with a plurality of media sheets denoted by reference numerals 58, 60, 62.

With reference to FIG. 4, each of the nip roller pairs 26-1 through 26-8 has one of the sensors 28 disposed adjacent thereto on the input side thereof to sense the arrival of the leading edge of the sheet at the respective pair of nip rollers.

Referring to FIG. 4, the sheet 62 as shown between the nip roller pairs 26-7 and 26-8 has a reference sheet velocity vd1 and the nip rollers have desired nip velocities sd7 and sd8. The sheet 60 passing through the nip roller pairs 26-2 through 26-6 has a reference sheet velocity vd2; and, the nip rollers have respectively desired nip velocities denoted sd1 through sd6. The sheet velocity of the sheet 58 entering the nips 26-1 has a reference sheet velocity denoted vd3 in FIG. 4. It will be understood that each of the pairs of nip rollers 26-1 through 26-8 is driven by an individual drive motor (such as motor 29 in FIG. 3) which permits separate individual control of the surface velocities of each pair of nip rollers.

In the media path shown in FIG. 4, the nip rollers that touch a sheet are assigned that sheet's desired velocity; whereas nip rollers that are empty are assigned the incoming or upstream sheet's desired velocity. With reference to FIG. 4, the following applies:

sd1=sd2=vd3

sd3=sd4=sd5=sd6=vd2

sd7=sd8=vd1

The assignment of the nip velocities for the empty nip rollers of the desired sheet velocity of the upstream or incoming sheet thus reduces the possibility of skewing, jamming or tearing of the sheet when entering each pair of nip rollers.

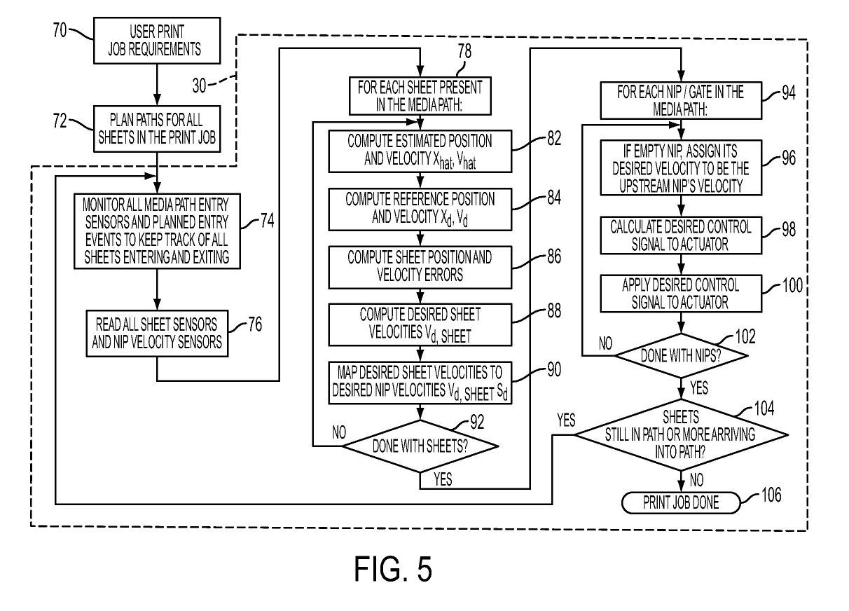

Referring to FIG. 5, the operation of the controller 30 is shown in block flow diagram wherein at step 70 the user print job requirements are inputted to the path planner 48 (see FIG. 2) at step 72 and the controller 30 receives the instructions for the sheet path plan at step 74 and monitors the media path entry sensors and entry events for all sheets entering and exiting the media path. The controller proceeds at step 76 to read all the sheet sensors and the nip roller velocity sensors. The system then proceeds to step 78 to apply the algorithm of the present disclosure and perform the calculations for each sheet in the media path as follows. The system proceeds to step 80 and computes the estimated position xₕₐₜ and the velocity vₕₐₜ. Upon completion of the computations in step 80, the system proceeds to step 82 and computes the reference position x_{d} and the velocity v_{d} at step 84.

The sheet observer 40 generates estimates of the positions and velocities xₕₐₜ and vₕₐₜ of all sheets in the media path using a model based estimator and utilizing all control signals such as motor voltages, motor current, step motor pulses, gate actuation signals, and all sensor signals including encoder, tachometer, and sheet sensor signals from optical or mechanical point sensors or array sensors.

The sheet controllers 32 generate control signals for desired sheet velocities v_{d,sheet} to insure that all the sheets stay on track and follow their respective reference trajectories. Control is determined as a function of the reference trajectories and the actual sheet positions and velocities as determined by the sheet observer 40. The system may utilize proportional control with velocity feed-forward for enhanced stability, zero-state tracking error and ease of tuning.

Referring to FIG. 5, the system proceeds to step 86 and computes the sheet position and velocity errors based upon the computations of steps 82 and 84.

The system then proceeds to step 88 and computes the desired sheet velocity according to the algorithm

v_{d} sheet=Kₚ(x_{d}−xₕₐₜ)+v_{d}

where Kₚ is a controller proportional gain constant, x_{d} is the current reference trajectory position, xₕₐₜ is the current estimated sheet position, and v_{d} is the current reference trajectory velocity.

The system then proceeds to step 90 and maps the desired sheet velocities v_{d,sheet} to desired nip velocities s_{d} for each nip roller pair in the selected media path.

Utilizing the desired nip velocities from step 90, and the actual or estimated nip velocity from the nip motor sensors or step motor pulses, each nip controller 36 generates a nip motor control signal u which may include voltage, current or step motor pulses to insure that the nip velocity s tracks the desired nip velocity s_{d}. The system then proceeds to step 92 and enquires as to whether all sheets present in the media path have been processed; and, if the answer is affirmative, the system proceeds to step 94 where, for each nip in the media path, proceeds to assign its desired velocity to be the upstream nip velocity if the nip is empty at step 96, for each gate in the media path, proceeds to generate an actuation voltage/step motor pulses to actuate the gate to the desired position in anticipation for the next sheet to reach it so that the sheet is diverted into the correct part of the media path.

The system then proceeds to step 98 and calculates the desired control signal for the actuator such as one of the nip motors 29 or one of the gate solenoids 27-1, 27-2 at step 100.

However, if the determination at step 92 is negative, the system recycles to step 82.

The system then proceeds to step 102 and enquires as to whether all nips in the path have been processed; and, if the determination at step 102 is affirmative, the system proceeds to step 104 and enquires if there are sheets still in the path or more arriving into the path. If the determination at step 102 is negative, the system recycles to step 96.

If the determination at step 104 is affirmative, the system recycles to step 74; however, if the determination at step 104 is negative, the print job is considered complete at step 106.

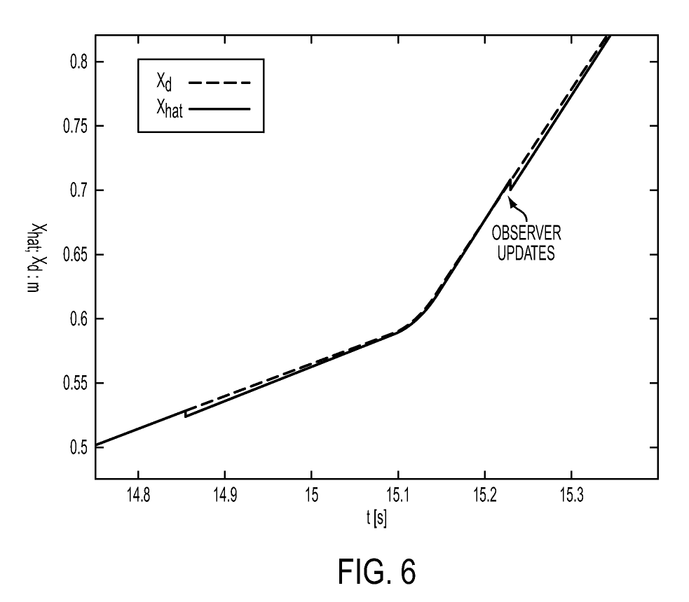

Referring to FIGS. 6 and 1, measurements of the estimated sheet position xₕₐₜ and the reference sheet position x_{d} were taken for a sheet traversing the path in the on-ramp portion of an IME as indicated in FIG. 1. The data for both xₕₐₜ and x_{d} were plotted as a function of time and resultant plot is illustrated in FIG. 6 wherein it is noted in which the values of xₕₐₜ are plotted graphically in solid line and those of x_{d} in dashed line. It is noted that where the sensors updated the control algorithm at about 14.85 seconds and about 15.22 seconds the actual subsequent position of the leading edge of the sheet was made to coincide with the desired reference trajectory position x_{d}.

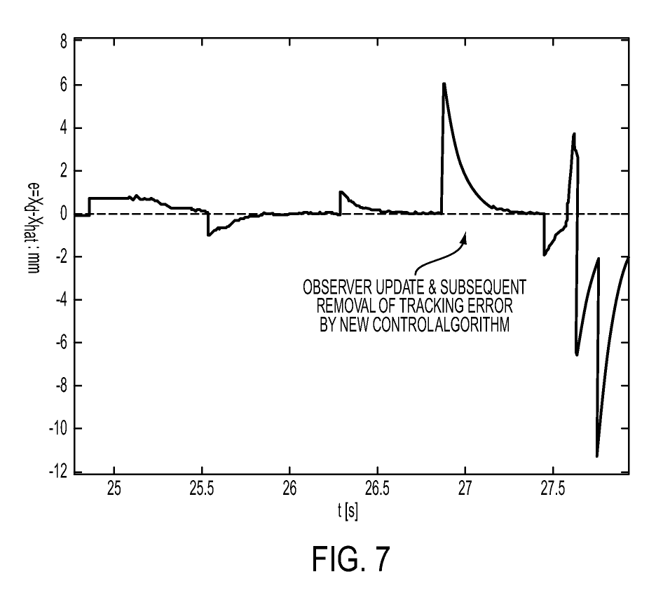

Referring to FIGS. 3 and 7, the sheet tracking errors that is the difference between the reference position x_{d} and the estimated position xₕₐₜ have been plotted from the entry at sensor 128 of the module shown in FIG. 3 to just slightly upstream of the sensor 628. It is to be noted that this sensor 628 is the second bend in the media path which induces additional disturbances on sheets. After this latter bend, the sheets exit the output module and all control actions terminate, thus no removal of these errors is possible. The media path traversed by the sheets includes one 90 degree bend and is approximately 0.6 meters long; and, the results of these trials have been summarized in Table 1 which shows the mean tracking errors and their range for the three print jobs run for comparison purposes.

FIG. 7 shows a plot of the tracking error as a function of time; and, the point in time wherein the control algorithm operates to begin removing the tracking error is noted as beginning at about 26.8 seconds.

Referring to Table 1, the data for the three print jobs performed for comparison purposes is given for the sensor locations 128, 228, 328, 428, 528, and 628 for the module of FIG. 3. The media employed for Job 1 comprise standard 4024, 75 gsm paper; and, the media employed for Jobs 2 and 3 comprised a mix of 2 sheets of 60 gsm, 2 sheets of 75 gsm 4024, 2 sheets of 90 gsm, 2 sheets of 199 gsm glossy card stock, and 2 sheets of 216 gsm matte card stock. Jobs 1 and 2 were run with existing open loop control and Job 3 was printed employing the new control algorithm of the present disclosure.

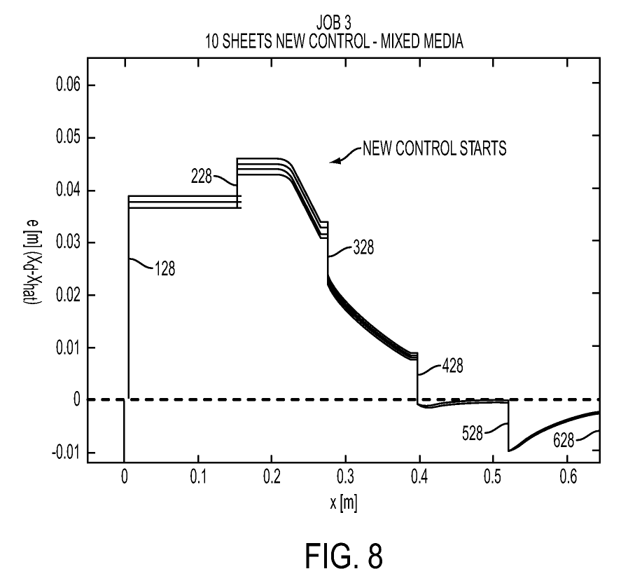

Referring to FIG. 8, the tracking error x_{d}−xₕₐₜ is plotted as a function of path position and shows that initially, the tracking error was about 40 mm at sensor 128; whereas, by the time the sheet leading edge reached sensor 628, the tracking error has been reduced to less than 5 mm.

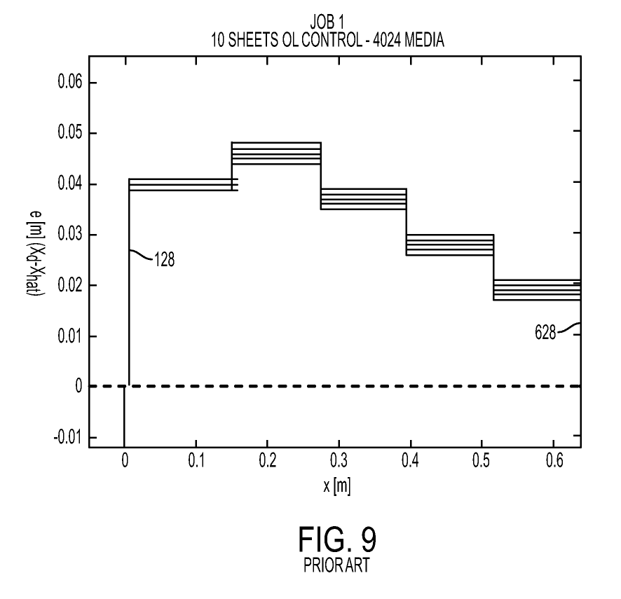

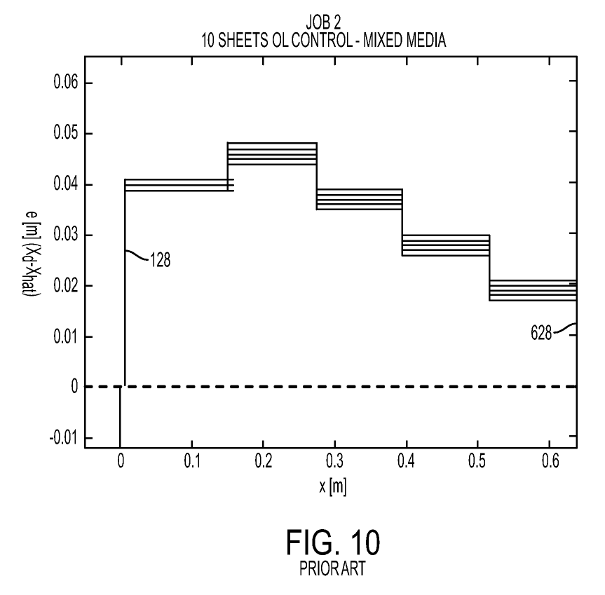

Referring to FIGS. 9 and 10, the tracking error for Jobs 1 and 2 employing the existing open loop control show that for the same path movement, the tracking error happened to be reduced from the initial 40 mm to 20 mm, but could also have increased to 60 mm since there was no active control, only random disturbances acting on the sheets, thus, upon comparison with Table 1, illustrates the substantially greater reduction in tracking error for control of the nip drives by using the presently disclosed algorithm.

TABLE I
Experimental Data: 3 print jobs, 10 sheets each

| | Job 1: | | Job 2: | | Job 3: | |
|---|---|---|---|---|---|---|
| | 4024 media | | Mixed media | | Mixed media | |
| | Open Loop Control | | Open Loop Control | | New control | |
| Update location | Mean error | Range | Mean error | Range | Mean error | Range |
| [m] | [mm] | [mm] | [mm] | [mm] | [mm] | [mm] |
| Entry 128 | +40 | 2.0 | +40 | 2.0 | +38 | 2.0 |
| x = 0.005 | | | | | | |
| 228 | +46 | 2.0 | +46 | 4.0 | +44 | 4.0 |
| x = 0.151 | | | | | | (control |
| | | | | | | starts here) |
| 328 | +37 | 2.0 | +37 | 4.0 | +23 | 2.0 |
| x = 0.274 | | | | | | |
| 428 | +28 | 2.0 | +28 | 4.0 | −1.0 | 0.0(*) |
| x = 0.397 | | | | | | |
| 528 | +19 | 2.0 | +19 | 4.0 | −10 | 0.0(*) |
| x = 0.520 | | | | | | |
| just upstream of 628 | +19 | 2.0 | +19 | 4.0 | −2.8 | 0.2 |
| x = 0.642 | | | | | (control still | |
| | | | | | removing | |
| | | | | | error) | |

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method of controlling print media flow in digital printing comprising:
(a) providing a digital print engine with a plurality of media sheet nip rollers defining at least one sheet path within the print engine;
(b) disposing at least one print media sheet feeder proximate the print engine;
(c) driving each of the nip rollers individually with a variable speed motor and propelling the print media through said at least one path;
(d) sensing the position of each media sheet in the path and providing a sheet position signal indicative of the position of the sheet at a known time;
(e) providing a controller responsive to the sheet position signal and effecting timed feeding of sheets from the feeder to the engine and determining a desired path and arrival times through selected ones of the nip rollers; and,
(f) mapping the sensed media sheet positions and generating a speed control signal for each motor based upon the sensed media sheet position and driving the motor at a desired speed to position the sheet on the selected path at a desired position.

2. The method defined in claim 1, wherein the step of generating a speed control signal includes generating a desired nip velocity signal s_{ds} according to s_{ds}=Kₚ(x_{d}−xₕ)+v_{d}, where s_{ds} is the desired nip surface velocity, x_{d} is the current desired sheet position in the path, xₕₐₜ is the estimated sheet position, Kₚ is a proportional gain of the controller, and v_{d} is the velocity of the desired sheet position.

3. The method defined in claim 1, wherein the step of providing a controller includes providing a sheet controller for determining the desired sheet path through the engine and a nip controller for controlling each of the motors.

4. The method defined in claim 1, wherein the step of a controlling each motor includes driving downstream nip rollers at the same speed as the next adjacent upstream nip rollers in the media sheet path, when a sheet is not in contact with the downstream nip rollers.

5. The method defined in claim 1, wherein the step of generating a speed control signal includes generating pulses for a stepper motor.

6. The method defined in claim 1, wherein the step of generating a speed control signal includes employing an encoder.

7. The method defined in claim 1, wherein the step of controlling each motor includes generating a motor control signal including proportional control and velocity feed forward.

8. The method defined in claim 1, wherein the step of generating a speed control signal includes the step of generating a signal selected from one of voltage, current and stepper motor pulses.

9. The method defined in claim 1, wherein the step of sensing includes disposing sensors selected from one of optical and mechanical.

10. The method defined in claim 1, wherein the step of sensing the position of each media sheet includes disposing a sensor before each split point in the path, before each merge point in the path and after each bend in the path.

11. A system for controlling sheet media in a digital print engine comprising:
(a) a media sheet feeder disposed proximate the print engine and operative for timed feeding of sheets thereto;
(b) a plurality of nip rollers in the engine disposed at progressive stations for defining a sheet media path therethrough;
(c) a print job controller operative to define a desired media sheet path through selected nip rollers;
(d) a sensor disposed proximate selected nip roller stations operative to sense media sheet position and provide a signal indicative thereof;
(e) a nip controller disposed to receive the signal from each of the sensors; and,
(f) a plurality of variable speed motors each disposed to drive one of the nips independently,
wherein the nip controller is operative in response to the sensor signal to map the sheet positions to drive the respective motor to provide a nip velocity sufficient to move a sensed media sheet to a desired position in the path.

12. The system defined in claim 11, wherein the sensor is selected from one of optical and mechanical.

13. The system defined in claim 11, wherein the nip controller is operative to provide a desired nip (sheet) velocity s_{ds} according to s_{ds}=Kₚ(x_{d}−xₕₐₜ)+v_{d}, where Kₚ is the proportional gain of the controller, x_{d} is the current reference path position, xₕₐₜ is the current estimated sheet position and v_{d} is the velocity of the desired sheet position.

14. The system defined in claim 11, wherein the nip controller is operative to generate a motor control signal selected from one of the voltage, current and step motor pulses.

15. The system defined in claim 11, wherein the sensor is selected from one of optical and mechanical.

16. The system defined in claim 11, wherein the nip controller is operative to control the position error of the media sheet within a predetermined band.

17. The system defined in claim 11, wherein the nip controller is operative to provide a motor drive signal including proportional control and velocity feed forward.

18. The system defined in claim 11, wherein the digital print engine includes an endless media sheet transport belt.

19. The system defined in claim 11, wherein the sensor disposed proximate selected nip stations includes a sensor disposed before each split point in the path, before each merge point in the path and after each bend in the path.

20. The system defined in claim 11, wherein the sensor is operative to sense the surface velocity of the nip roller and provide a signal indicative thereof.

21. A method of controlling print media flow in digital printing comprising:
(a) providing a digital print engine with a plurality of media sheet nip rollers defining at least one sheet path within the print engine;
(b) disposing a print media sheet feeder proximate the print engine;
(c) driving each of the nip rollers individually with a variable speed motor and propelling the print media through the path;
(d) disposing a sensor at stations proximate selected nip rollers and sensing sheet position at a known time;
(e) providing a controller and effecting timed feeding of sheets from the feeder to the engine and determining desired path and arrival times through selected nip rollers for each of a plurality of sheets fed in the path;
(f) mapping the sensed sheet positions and generating a speed control signal for each motor based upon the sensed position of each of the plurality of sheets and driving the respective motor to position the respective sheet on the selected path at a desired position and arrival time.

22. The method defined in claim 21, wherein the step of generating a speed control signal includes generating a desired nip roller surface velocity signal s_{ds} according to s_{ds}=Kₚ(x_{d}−xₕₐₜ)+v_{d} where s_{ds} is the desired sheet velocity, x_{d} is the current sensed sheet position in the path, xₕₐₜ is the estimated sheet position, Kₚ is a proportional gain of the controller and v_{d} is the velocity of the desired sheet position.

23. The method defined in claim 21, wherein the step of disposing a sensor includes disposing a sensor before each split point in the path, before each merge point in the path and after each bend in the path.

24. A system for controlling sheet media in a digital print engine comprising:
(a) a media sheet feeder disposed proximate the print engine and operative for timed feeding of sheets thereto;
(b) a plurality of nip rollers in the engine disposed at progressive stations for defining a sheet media path therethrough;
(c) a print job controller operative to define a desired media sheet path through selected nip rollers;
(d) a sensor disposed proximate each of a plurality of selected nip roller stations and operative to sense media sheet position and provide a signal indicative thereof;
(e) a plurality of sheet controllers operative to receive the originals from the sensors; and,
(f) a plurality of variable speed motors each disposed to drive one of the nips independently.
